(19) United States
(12) Patent Application Publication
(10) Pub. No.: US 2011/0189619 A1
(43) Pub. Date: Aug. 4, 2011

(54) HEAT ACCUMULATOR COMPOSITE MATERIAL

(75) Inventor: Robert Lloyd, Galston (AU)

(73) Assignee: I-SOL VENTURES GmbH, Berlin (DE)

(21) Appl. No.: 12/918,719

(22) PCT Filed: Feb. 20, 2009
(86) PCT No.: PCT/EP2009/052054

§ 371 Date: Apr. 20, 2011

(30) Foreign Application Priority Data
Feb. 20, 2008 (DE) 10 2008 010 746.8

(51) Int. Cl. F24J 3/00; B32B 9/04; B32B 3/00; B32B 5/00; B32B 15/00; B32B 1/08; C09K 5/00

(52) U.S. Cl. 432/1; 428/411.1; 428/141; 428/98; 428/614; 428/34.1; 428/702; 252/71

(57) ABSTRACT

The present invention relates to a heat accumulator composite material, a method for the manufacture thereof and a heat accumulator device. The object of the invention is therefore to provide heat accumulator materials, a method for the manufacture thereof and heat accumulator devices that exhibit high thermal capacities and heat accumulator capacities. The solution of the object is accomplished through a heat accumulator composite material that comprises a plurality of carbon particles and a thermally conducting material, wherein the material differs from the carbon particles. The manufacture of the thermal accumulator composite material according to the invention is accomplished by combining a plurality of carbon particles and a thermally conducting material for the formation of a mixture, and heating the mixture in a partial vacuum to a temperature above the melting point of the thermally conducting material.

### TECHNICAL FIELD

The present invention relates to a heat storage composite and to a process for making it.

### SUMMARY OF THE INVENTION

In a first aspect of the invention there is provided a heat storage composite comprising:
a plurality of carbon particles; and
a thermally conductive material.

The carbon particles may be distributed through the thermally conductive material. The plurality of carbon particles may define spaces between said particles, and the thermally conductive material may occupy at least some of said spaces, optionally all of said spaces. The heat storage composite of the present invention may comprise a thermally conductive material having carbon particles therein. The carbon particles may be substantially homogeneously distributed in the thermally conductive material.

The following options are available for this aspect either individually or in any combination.

The carbon of the carbon particles may have a purity of at least about 99% by weight, or at least about 99.9% by weight. It may be in the form of graphite.

The mean particle diameter of the carbon particles may be less than about 2 mm, or less than about 1 mm, or less than about 500, 200 or 100 microns. The carbon particles may have a broad particle size distribution. The weight average particle size of the carbon particles divided by their number average particle size may be greater than about 3, or greater than about 5 or greater than about 10. The carbon particles may be substantially spherical.

The heat storage composite may comprise at least about 50% by volume of carbon, or at least about 60, 70 or 80% by volume of carbon particles.

The thermally conductive material may have a conductivity of at least about 3 W/cm K at 300K. It may be a metal or a metal alloy. It may be for example copper, silver or a copper-silver alloy.

Substantially all of the spaces may be occupied by the thermally conductive material.

In an embodiment there is provided a heat storage composite comprising:
a plurality of carbon particles; and
a thermally conductive material;
   wherein the carbon particles are distributed through the thermally conductive material.

In another embodiment there is provided a heat storage composite comprising:
a plurality of substantially spherical carbon particles having mean diameter of less than about 2 mm; and
a thermally conductive material
   wherein the carbon particles are distributed through the thermally conductive material.

In another embodiment there is provided a heat storage composite comprising:
a plurality of substantially spherical carbon particles having mean diameter of less than about 2 mm; and
a metal or metal alloy having a thermal conductivity of at least about 3 W/cm K at 300K;
   wherein the carbon particles are distributed through the thermally conductive material.

In another embodiment there is provided a heat storage composite comprising:
a plurality of substantially spherical carbon particles having mean diameter of less than about 2 mm; and
a metal or metal alloy having a thermal conductivity of at least about 3 W/cm K at 300K;
   wherein the carbon particles are distributed through the thermally conductive material and wherein said heat storage composite comprises at least about 70% by volume carbon.

In a second aspect of the invention there is provided a heat storage block comprising the heat storage composite of the first aspect.

The following options are available for this aspect either individually or in any combination.

The heat storage block may comprise an outer layer consisting of a substance of low thermal emissivity. The substance of low thermal emissivity may be highly polished. The low thermal emissivity may be less than about 0.05 at the operating temperature of the block. The substance of low thermal emissivity may be the same as the thermally conductive material.

The heat storage block may be in the form of a rectangular parallelepiped, e.g. a cube.

The heat storage block may comprise a heating chamber for accepting a substance to be heated by said heat storage block. The heating chamber may be designed so as to allow a substance to pass through said heating block, thereby heating said substance.

The heat storage block may additionally comprise a heater component for heating said heat storage composite. The heater component may comprise an electrical element, a conduit for a heat exchange fluid or some other heater component.

In an embodiment there is provided a heat storage block comprising the heat storage composite of the first aspect, said block comprising an outer layer consisting of a highly polished substance of low thermal emissivity.

In another embodiment there is provided a heat storage block comprising the heat storage composite of the first aspect, said block comprising an outer layer consisting of the thermally conductive material, said thermally conductive material being highly polished and having low thermal emissivity.

In another embodiment there is provided a heat storage block in the form of a rectangular parallelepiped comprising a heating chamber designed so as to allow a substance to pass through said heating block thereby heating said substance, said block comprising the heat storage composite of the first aspect and an outer layer consisting of the thermally conductive material, said thermally conductive material being highly polished and having low thermal emissivity.

In another embodiment there is provided a heat storage block comprising the heat storage composite of the first aspect and a heater component for heating said storage block, said block comprising an outer layer consisting of a highly polished substance of low thermal emissivity.

In another embodiment there is provided a heat storage block in the form of a rectangular parallelepiped comprising a heating chamber designed so as to allow a substance to pass through said heating block thereby heating said substance, said block consisting essentially of the heat storage composite of the first aspect, a heater component for heating said storage block, and an outer layer consisting of the thermally conductive material, said thermally conductive material being highly polished and having low thermal emissivity.

In a third aspect of the invention there is provided a heat storage device comprising:
a heat storage block according to the second aspect mounted in a region of low pressure; and
a heater for heating said heat storage block.

The following options are available for this aspect either individually or in any combination.

The low pressure may be less than about 0.01 atmospheres.

The heat storage block may be mounted in said region of low pressure by means of a thermal insulator. The thermal insulator may have a thermal conductivity of less than about 0.5 W/cm K at 373K. The thermal insulator may comprise fused alumina or oriented graphite or both.

The heater may comprise an electrical heater, a heat exchange fluid based heater, an inductive heater, an eddy current heater or some other heater.

In an embodiment there is provided a heat storage device comprising:
a heat storage block according to the second aspect mounted in a region of less than about 0.01 atmospheres; and
a heater for heating said heat storage block.

In another embodiment there is provided a heat storage device comprising:
a heat storage block according to the second aspect mounted in a region of less than about 0.01 atmospheres by means of a thermal insulator having a thermal conductivity of less than about 0.5 W/cm K at 373K; and
a heater for heating said heat storage block.

In another embodiment there is provided a heat storage device comprising:
a heat storage block according to the second aspect mounted in a region of less than about 0.01 atmospheres by means of a thermal insulator having a thermal conductivity of less than about 0.5 W/cm K at 373K; and
an eddy current heater for heating said heat storage block.

In a fourth aspect of the invention there is provided a process for making a heat storage composite comprising:
combining a plurality of carbon particles and a thermally conductive material to form a mixture; and
heating said mixture in a partial vacuum to a temperature above the melting point of the thermally conductive material.

The partial vacuum may be applied to the mixture before the thermally conductive material is raised above its melting point. The mixture may be substantially homogeneous. Prior to the step of heating, the thermally conductive material may be in particulate form. The particles of the thermally conductive material may be less than about 20 microns in mean diameter. The heat storage composite may be according to the first aspect of the invention. The options described above for the first aspect may also be applied to the fourth aspect where appropriate.

The invention also provides a heat storage composite made by the process of the fourth aspect.

In a fifth aspect of the invention there is provided a process for making a heat storage block comprising:
making a heat storage composite according to the process fourth aspect; and
forming the heat storage composite into a desired shape.

The heat storage block may be according to the second aspect of the invention. The options described above for the second aspect may also be applied to the fourth aspect where appropriate.

The following options are available for this aspect either individually or in any combination.

The process may additionally comprise the step of applying a substance of low thermal emissivity to an outer surface of said shape. This step may comprise spraying a film of said substance on said outer surface. The process may additionally comprise the step of polishing said substance of low thermal emissivity on said outer surface.

The desired shape may be a rectangular parallelepiped, e.g. a cube.

The desired shape may comprise a heating chamber for accepting a substance to be heated by said heat storage block. The heating chamber may comprise a cone or a cylinder passing substantially vertically through the block.

The process may comprise incorporating a heater component into the heat storage block.

In an embodiment there is provided a process for making a heat storage block comprising:
making a heat storage composite according to the process of the fourth aspect;
forming the heat storage composite into a desired shape; and
applying a substance of low thermal emissivity to an outer surface of the shape.

In another embodiment there is provided a process for making a heat storage block comprising:
making a heat storage composite according to the process of the fourth aspect;
forming the heat storage composite into a rectangular parallelepiped comprising a cone or a cylinder passing substantially vertically through said rectangular parallelepiped; and
applying a substance of low thermal emissivity to an outer surface of said rectangular parallelepiped.

In another embodiment there is provided a process for making a heat storage block comprising:
making a heat storage composite according to the process of the fourth aspect;
forming the heat storage composite into a desired shape;
incorporating a heater component into the heat storage block; and
applying a substance of low thermal emissivity to an outer surface of the shape.

The invention also provides a heat storage block made by the process of the fifth aspect.

In a sixth aspect of the invention there is provided a process for making a heat storage device comprising:
providing a heat storage block according to the invention;
providing a heater for heating said heat storage block;
mounting said heat storage block inside a chamber; and
removing at least part of the gas inside said chamber so as to create a region of low pressure surrounding said heat storage block.

The following options are available for this aspect either individually or in combination.

The mounting may comprise providing mountings which are made from a thermal insulator.

The step of providing the heat storage block may comprise making said heat storage block using the process the fifth aspect.

In an embodiment there is provided a process for making a heat storage device comprising:
making a heat storage block using the process the fifth aspect;
providing a heater for heating said heat storage block;
mounting said heat storage block inside a chamber; and
removing at least part of the gas inside said chamber so as to create a region of low pressure surrounding said heat storage block.

The invention also provides a heat storage device made by the process the sixth aspect.

In a seventh aspect of the invention there is provided a method for heating a substance comprising:
a) providing a heat storage device according to the invention, wherein the heat storage block of said device is at a temperature above that of the substance; and
b) exposing the substance to the heat storage block so as to heat the substance.

The following options are available for this aspect either individually or in any combination.

Step a) may comprise heating the heat storage block to said temperature using the heater.

Step b) may comprise passing the substance through a heating chamber in said block, said chamber being designed so as to allow the substance to pass through said heating block.

In an embodiment there is provided a method for heating a substance comprising:
a) heating a heat storage device according to the invention to a temperature above that of the substance; and
b) passing the substance through a heating chamber in said block, said chamber being designed so as to allow the substance to pass through said heating block.

The invention also provides a heated substance when heated by the method of the seventh aspect. It also provides the use of a heat storage device according to the present invention, or of a heat storage block according to the present invention, or of a heat storage composite according to the present invention, for heating a substance.

### BRIEF DESCRIPTION OF THE DRAWINGS

A preferred embodiment of the present invention will now be described, by way of an example only, with reference to the accompanying drawings wherein:

FIG. 1 is a diagram illustrating the manufacture of a heat storage composite, heat storage block and heat storage device according to the present invention; and

FIG. 2 illustrates the use of the heat storage device of FIG. 1 to heat a substance.

### DETAILED DESCRIPTION OF THE PREFERRED EMBODIMENTS

The present invention relates to a heat storage composite which comprises a plurality of carbon particles and a thermally conductive material which is different to the carbon particles. In the context of this specification, a composite may be taken to be a structure or an entity made up of distinct components. The composite may be a mixture. It may be a solid at room temperature. It may be a solid at its maximum operating temperature.

The thermally conductive material may represent a continuous phase. The thermally conductive material may have the carbon particles distributed, e.g. embedded, therein. They may be distributed or embedded therein substantially homogeneously. The thermally conductive material may form a continuous path for thermal conduction through the heat storage composite. The carbon particles may represent a discontinuous phase within the continuous phase of the thermally conductive material. Thus the heat storage composite of the present invention may comprise the thermally conductive material having carbon particles therein, optionally homogeneously distributed therein. In the heat storage composite of the invention, the carbon particles may serve as heat storage regions and the thermally conductive material may serve to conduct heat to the carbon particles when the heat storage composite is being heated, and to conduct heat from the carbon particles to a substance to be heated when the heat storage composite is being used to heat the substance.

In the invention it may be advantageous to use high purity carbon. Impurities in the carbon may reduce the heat capacity of the block, and may decompose at high temperatures attained during use of the heat storage composite to impair the integrity of the composite and/or to generate unwanted (e.g. noxious) products. The carbon of the carbon particles may have a purity of at least about 99% by weight, or at least about 99.5, 99.9, 99.95 or 99.99% by weight, for example about 99, 99.1, 99.2, 99.3, 99.4, 99.5, 99.6, 99.7, 99.8, 99.9, 99.91, 99.92, 99.93, 99.94, 99.95, 99.96, 99.97, 99.98, 99.99 or greater than 99.99%. It may be in the form of graphite or some other type of carbon, e.g. high purity anthracite. This may be obtained for example by the process of WO03/074639, the contents of which are incorporated herein by cross-reference.

The carbon particles are preferably small particles. The smaller the particles the larger the surface area of particles in a particular volume of heat storage composite, and therefore the better the heat transfer between the carbon particles and the thermally conductive material. The mean (weight average or number average) particle diameter of the carbon particles may be less than about 2 mm, or less than about 1 mm, or less than about 500, 200, 100, 50, 20 or 10 microns, or between about 1 micron and about 2 mm, or about 10 microns to 2 mm, 50 microns to 2 mm, 100 microns to 2 mm, 500 microns to 2 mm, 1 to 2 mm, 10 microns to 1 mm, 10 to 500 microns, 10 to 100 microns, 10 to 50 microns, 10 microns to 1 mm, 10 to 500 microns, 10 to 200 microns, 10 to 100 microns, 100 to 500 microns 50 to 50 microns or 50 to 200 microns, e.g. about 1, 2, 3, 4, 5, 6, 7, 8, 9, 10, 20, 30, 40, 50, 60, 70, 80, 90, 100, 150, 200, 250, 300, 350, 400, 450, 500, 550, 600, 650, 700, 750, 800, 850, 900 or 950 microns, or about 1, 1.1, 1.2, 1.3, 1.4, 1.5, 1.6, 1.7, 1.8, 1.9 or 2 mm. In this context, the particle diameter of a non-spherical particle is taken to be the mean diameter of the particle. The carbon particles may have a broad particle size distribution. This may facilitate packing of the particles, since smaller particles may fit in the spaces between larger particles. This in turn enables a higher proportion of carbon particles in the heat storage composite, thereby enabling a higher heat capacity of the composite to be achieved. Since carbon is less dense (i.e. has a lower specific gravity) than most suitable thermally conductive materials (many of which are metals), this benefit is particularly great on a weight basis. Thus the present invention may provide a composite that is relatively light weight while providing suitable heat storage and transfer properties compared with prior art materials capable of providing this combination of properties. A measure of the particle size distribution is the weight average particle size of the carbon particles divided by their number average particle size. This value may, for the composite of the present invention, be greater than about 3, or greater than about 4, 5, 6, 7, 8, 9 or 10, or may be about 3 to 20, 5 to 20, 10 to 20, 3 to 10, 3 to 5 or 5 to 10, e.g. about 3, 4, 5, 6, 7, 8, 9, 10, 11, 12, 13, 14, 15, 16, 17, 18, 19 or 20. In order to facilitate packing of the carbon particles, the particles should be a suitable shape. The carbon particles may be substantially spherical, or may be ovoid, polyhedral (with 6, 7, 8, 9, 10, 11, 12, 13, 14, 15, 16, 17, 18, 19, 20 or more than 20 faces), optionally regular polyhedral. In this context, substantially spherical describes an object with no sharp edges and having a sphericity of at least about 0.95, or at least about 0.96, 0.97, 0.98 or 0.99, or about 0.95 to 1, 0.96 to 1, 0.97 to 1, 0.98 to 1, 0.99 to 1, e.g. about 0.95, 0.96, 0.97, 0.98, 0.99 or 1. Alternatively the particles may have a sphericity of at least about 0.95, or at least about 0.96, 0.97, 0.98 or 0.99, or about 0.95 to 1, 0.96 to 1, 0.97 to 1, 0.98 to 1, 0.99 to 1, e.g. about 0.95, 0.96, 0.97, 0.98, 0.99 or 1, while having at least one sharp edge.

In the heat storage composite of the invention, the carbon particles provide high heat capacity. The thermally conductive material between the particles may have a lower heat capacity, however provides good thermal conductivity through the heat storage composite, and in some embodiments also provides a low emissivity coating on the outside of the composite. It is therefore advantageous to increase the proportion of carbon in the heat storage composite. The heat storage composite may comprise at least about 50% by volume of carbon, or at least about 60, 70, 80 or 90% by volume carbon, or about 50 to about 95%, or about 50 to 90, 50 to 80, 50 to 70, 70 to 95, 80 to 95 or 70 to 90%, e.g. about 50, 55, 60, 65, 70, 75, 80, 85, 90 or 95%. Additionally, it is preferable to minimise the amount of gas (e.g. air) in the heat storage composite, since gases provide relatively low thermal conductivity and relatively low heat capacity. It is therefore desirable that substantially all of the spaces be occupied by the thermally conductive material. At least about 80% of the volume of the spaces may be occupied by thermally conductive material, or at least about 85, 90, 95, 96, 97, 98, 99, 99.5 or 99.9% of the volume of the spaces. About 80% of the volume of the spaces may be occupied by thermally conductive material, or about 85, 90, 91, 92, 93, 94, 95, 95.5, 96, 96.5, 97, 97.5, 98, 98.5, 99, 99.1, 99.2, 99.3, 99.4, 99.5 99.6, 99.7, 99.8 or 99.9% of the volume of the spaces. The carbon particles may be homogeneously distributed through the thermally conductive material.

The thermally conductive material may have a conductivity of at least about 3 W/cm K at 300K or at the operating temperature of the composite, or at least 3.5, 4 or 4.5 W/cm, or between about 3 and about 5, or between about 3.5 and 5, 4 and 5, 4.5 and 5, 3.5 and 4.5 or 4 and 4.5, e.g. about 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9 or 5 W/cm. It may be a metal or a metal alloy having a melting point below that of carbon (e.g. below about 3500° C.). It may be for example copper, silver or a copper-silver alloy. The thermally conductive material may have a purity of at least about 99% by weight, or at least about 99.5, 99.9, 99.95 or 99.99% by weight, for example about 99, 99.1, 99.2, 99.3, 99.4, 99.5, 99.6, 99.7, 99.8, 99.9, 99.91, 99.92, 99.93, 99.94, 99.95, 99.96, 99.97, 99.98, 99.99 or greater than 99.99%. It may be sufficiently pure that no volatile substances are released therefrom when the metal is heated to the operating temperature of the heat storage composite.

The heat storage composite may have a heat capacity that increases with temperature. The heat capacity at 1000° C. may be at least about 1.5 J/g K, or at least about 1.6, 1.7, 1.8, 1.9 or 2 J/g K, or may be between about 1.5 and about 4 J/g K, or about 1.5 to 3, 1.5 to 2, 2 to 4, 3 to 4, 2 to 3 or 2 to 2.5, e.g. about 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9 or 4, or may be more than 4 J/g K. A metric ton (i.e. 1 tonne) block of the heat storage composite may be capable of storing at least about 500 kWh of thermal energy, or at least about 550, 600, 650, 700, 750, 800, 850, 900, 950 or 1000 kWh, or between about 500 and about 1000 kWh or about 500 to 900, 500 to 800, 500 to 700, 600 to 1000, 700 to 1000, 800 to 1000, 600 to 900 or 600 to 800 kWh, e.g. about 500, 550, 600, 650, 700, 750, 800, 850, 900, 950 or 1000 kWh.

The thermally conductive material should have a melting point below that of the carbon particles. Carbon has a melting point of about 3500° C. The thermally conductive material may also have a melting point above the use temperature of the thermally conductive material. Commonly the use temperature will be at least about 500° C., and may be greater than about 600, 700, 800, 900 or 1000° C., or about 500 to about 1000° C. or about 500 to 900, 500 to 800, 500 to 700, 500 to 600, 700 to 1000 or 600 to 900° C., e.g. about 500, 550, 600, 650, 700, 750, 800, 850, 9000, 950 or 1000° C. The available use temperatures will depend on the melting point of the thermally conductive material.

The heat storage composite may have a density of between about 2 and about 10 g/cm³, or about 2 to 8, 2 to 6, 2 to 4, 2 to 3, 2 to 2.5, 2.5 to 3, 2.5 to 3.5, 4 to 10, 6 to 10, 4 to 8 or 4 to 6 g/cm³, e.g. about 2, 2.1, 2.2, 2.3, 2.4 2.5, 2.6, 2.7, 2.8, 2.9, 3, 3.1, 3.2, 3.3, 3.4, 3.5, 4, 4.5, 5, 5.5, 6, 6.5, 7, 7.5, 8, 8.5, 9, 9.5 or 10 g/cm³, depending on the nature and proportion of the thermally conductive material in the heat storage composite. This density may be measured at any suitable temperature, for example room temperature, or at the operating temperature of the heat storage composite (which may, as described elsewhere, be about 1000° C. or some other suitable operating temperature).

The present invention also provides a heat storage block comprising the heat storage composite of the invention. In some embodiments the block consists essentially of the heat storage composite, i.e. no other intentionally added materials are present. The heat storage block may comprise an outer layer consisting of a substance of low thermal emissivity. In some embodiments the entire outer layer consists of a substance of low thermal emissivity. The outer surface of the block may be highly polished so as to reduce its emissivity. In the event that the entire outer layer consists of a substance of low thermal emissivity, that substance of low thermal emissivity may be highly polished. The low thermal emissivity may be less than about 0.05 at the operating temperature of the block, or less than about 0.045, 0.04, 0.035, 0.03, 0.025 or 0.02, or about 0.02 to 0.05, 0.03 to 0.05, 0.04 to 0.05, 0.02 to 0.04, 0.02 to 0.03 or 0.03 to 0.04, e.g. about 0.02, 0.025, 0.03, 0.035, 0.04, 0.045 or 0.05. The substance of low thermal emissivity may be the same as the thermally conductive material, or it may be different to it. In some embodiments the substance of low thermal emissivity is optimised for low emissivity and the thermally conductive material is optimised for high conductivity. The substance of low thermal emissivity may form a layer on the outside of the heat storage block. The layer may be between about 0.1 and about 10 mm thick, or about 0.1 to 5, 0.1 to 2, 0.1 to 1, 0.1 to 0.5, 0.5 to 10, 1 to 10, 2 to 10, 5 to 10, 0.5 to 5, 0.5 to 2 or 1 to 5 mm, e.g. about 0.1, 0.2, 0.3, 0.4, 0.5, 0.6, 0.7, 0.8, 0.9, 1, 2, 3, 4, 5, 6, 7, 8, 9 or 10 mm. The layer may be of variable thickness or it may be of constant thickness.

In the context of the present specification, the term “block” refers to a solid portion of the composite. The block may have flat sides or may have curved sides or may have some flat sides and some curved sides. The heat storage block may be any suitable shape. It may be in the form of a rectangular parallelepiped, a sphere, an ovoid, a torus, a cone, a polyhedron (with 6, 7, 8, 9, 10, 11, 12, 13, 14, 15, 16, 17, 18, 19, 20 or more than 20 faces), optionally a regular polyhedron, a cylinder (having either flat or curved ends), a truncated cone or some other suitable shape. It may be elongate with a polygonal cross section, where the polygon (optionally a regular polygon) has 4, 5, 6, 7, 8, 9, 10, 11, 12, 13, 14, 15, 16, 17, 18, 19, 20 or more than 20 faces. The dimensions of the block will depend on the nature of its use. The maximum, mean and minimum diameters of the block may, independently, be between about 10 cm and about 2 m or more than 2 m, or about 10 cm to 1 m, 10 to 50 cm, 10 to 20 cm, 20 cm to 2 m, 50 cm to 2 m, 1 to 2 m, 20 cm to 1 m, 50 cm to 1 m or 20 to 50 cm, e.g. about 10, 20, 30, 40, 50, 60, 70, 80 or 90 cm, or about 1, 1.1, 1.2, 1.3, 1.4, 1.5, 1.6, 1.7, 1.8, 1.9 or 2 m, provided of course that the maximum diameter is greater than or equal to the minimum diameter and the mean diameter is not greater than the maximum diameter and not less than the minimum diameter. If the block has discrete sides, each side may be as described above for the diameters, or may in some circumstances be smaller, e.g. about 0.5, 1, 1.5, 2, 2.5, 3, 3.5, 4, 4.5, 5, 6, 7, 8 or 9 cm.

The block may comprise a large number of carbon particles. Commonly it will have at least about 10⁵ carbon particles, but may have up to about 10¹⁶ carbon particles or more than 10¹⁶, depending on the size of the particles, their size distribution, the size and shape of the block and the packing density of the particles. There may be between about 10⁵ and 10¹⁵, 10⁵ and 10¹², 10⁵ and 10¹⁰, 10⁵ and 10⁸, 10⁶ and 10¹⁶, 10⁸ and 10¹⁶, 10¹⁰ and 10¹⁶, 10¹² and 10¹⁶, 10⁷ and 10¹², 10¹⁰ and 10¹⁴, 10⁸ and 10¹² or 10⁸ and 10¹⁰, e.g. about 10⁵, 10⁶, 10⁷, 10⁸, 10⁹, 10¹⁰, 10¹¹, 10¹², 10¹³, 10¹⁴, 10¹⁵ or 10¹⁶ carbon particles in the block.

The heat storage block may comprise a heating chamber for accepting a substance to be heated by said heat storage block. The heating chamber may be in the form of an indentation in the block, optionally in the top of the block, or a groove in the block (e.g. a V-shaped, or semicircular groove) in the block. It may pass through the block. It may pass through vertically. It may pass through horizontally. It may pass through at an angle between horizontal and vertical (e.g. 10, 20, 30, 45, 50, 60, 70 or 80 degrees to horizontal). It may be in the form of a channel through the block. The channel may be straight. It may be curved. It may be in the form of a coil or spiral channel through the block. It may have a circular cross-section, a polygonal cross-section, a star-shaped cross-section, an elliptical cross-section, a rectangular cross-section or some other type of cross-section. The channel may be in the form of a cylinder, a slot or some other form. The mean diameter of the chamber will depend on the required flow rate of a substance to be heated through the chamber, and on the nature (state of matter, viscosity) of the substance. The mean diameter may be between about 1 and about 50 mm, or about 1 to 20, 1 to 10, 1 to 5, 5 to 50, 10 to 50, 20 to 50, 5 to 20 or 10 to 20 mm, e.g. about 1, 2, 3, 4, 5, 6, 7, 8, 9, 10, 15, 20, 25, 30, 35, 40, 45 or 50 mm, although in particular embodiments it may be greater than 50 mm or less than 1 mm. The surfaces of the heating chamber may have a layer of the substance of low emissivity, or they may have no such layer. They may have a layer of a material of high thermal conductivity (e.g. greater than about 100 W/m K, or greater than about 110 or 120 W/m K, or between about 100 and about 150 W/m K, or about 100 to 130, 120 to 150, 110 to 130 or 115 to 115 W/m K, e.g. about 100, 105, 110, 115, 120, 125, 130, 135, 140, 145 or 150 W/m K at 300K). They may for example have a layer of silicon carbide. The layer may be as described earlier for the layer on the outer surface of the block. It may have the dimensions described for the layer on the outside of the block. The layer should be made from a substance that is resistant (i.e. not degraded, melted, vapourised or otherwise affected) to the substance to be heated in the heat storage block at the operating temperature thereof.

In some embodiments the heat storage block may have more than one (e.g. 2, 3, 4, 5, 6, 7, 8, 9, 10, 15, 20, 25, 30, 35, 40, 45, 50, 60, 70, 80, 90 or 100) heating chambers. These may each, independently, be as described earlier. If more than one chamber is present, they may be independent (i.e. may not connect with each other), or they may intersect (i.e. may connect with each other), or some may intersect and some be independent. In some embodiments the chambers take the form of an interconnecting network of pores. The mean diameter of the pores may be as described above for the diameter of the chamber. The provision of multiple heating chambers (particularly in the form of channels through the heat storage block) may result in a higher combined surface area of the heating chambers compared to a heat transfer block with only a single heating chamber. This leads to more efficient heat transfer to a substance to be heated by the block. However multiple heating chambers may each have smaller diameter than a single larger diameter heating chamber. This may lead to impedance of the flow of the substance to be heated through the heating chamber, and in some cases may causes blockages. The design and number of the heating chamber(s) may depend on the nature of the substance to be heated by the block. Thus if a gas is to be heated it may be preferable to have a large number of narrow channels through the block functioning as heating chambers, whereas if a powder or a viscous liquid is to be heated a single (or small number of) larger diameter channel(s) functioning as a heating chamber may be preferable.

The heating chamber may be designed so as to allow a substance to pass through said heating block, thereby heating said substance. The substance may be a solid. It may be a powder. It may be a liquid. It may be a gas. It may be a combination of any two or more of the above. Thus it may be a spray, an aerosol, a gaseous suspension, an emulsion, a foam etc. It may be a liquid at the operating temperature of the block and a solid at room temperature.

The heat storage block may additionally comprise a heater component for heating said storage element. The heater component may comprise an electrical element, a conduit for a heat exchange fluid or some other heater component. The heater component may be connectable to a source of energy. Thus for example the electrical element may be connectable to a source of electrical energy so that in use the heat storage block may be heated by passing an electric current through the electrical element so as to cause the element to heat the heater block. Alternatively the conduit may be connectable to a source of hot heat exchange fluid (e.g. hot gas or hot liquid) so that passing a hot heat exchange fluid from the source and through the conduit causes heating of the heat storage block. In some embodiments of the invention (which will be discussed later in this specification) the heat storage block does not have a heater component. The heater block may be heatable by means that do not comprise a heater component in and/or on the block. It may be heatable by induction.

The invention also provides a heat storage device comprising a heat storage block according to the invention, said block being mounted in a region of low pressure, and a heater for heating said heat storage block.

The heat storage device may be used for heating a substance by transfer of heat energy from the heat storage block of the device to the substance. It is desirable that energy losses from the heat storage block, other than those related to heating the substance, be as low as possible. In general, heat loss may be either through radiative loss, convective loss or conductive loss. Commonly the heater block of the present invention has a low emissivity outer surface. This serves to maintain low radiative losses. It is preferable to have the mounting of the heater block designed so that the mountings are highly insulating, and have as small as possible contact area with the heater block so as to maintain low conductive losses. In the heat storage device, the block is located in a region of low pressure, thereby reducing convective losses. The lower the pressure in said region, the lower the convective loss. The low pressure may be less than about 0.01 atmospheres, or less than about 0.005, 0.001, 0.0005 or 0.0001 atmospheres, or about 0.01 to 0.0001 atmospheres, or about 0.01 to 0.001, 0.01 to 0.005, 0.001 to 0.0001 or 0.01 to 0.0005 atmospheres, e.g. about 0.01, 0.005, 0.001, 0.0005 or 0.0001 atmospheres.

As mentioned above heat storage block may be mounted in by means of a thermal insulator. The thermal insulator may have a thermal conductivity of less than about 0.5 W/cm K at 373K, or less than about 0.4, 0.3, 0.2, 0.1, 0.5 or 0.01 W/cm K, or about 0.5 to about 0.01, 0.2 to 0.01, 0.1 to 0.01, 0.05 to 0.01, 0.5 to 0.1, 0.5 to 0.2, 0.2 to 0.05 or 0.1 to 0.05, e.g. about 0.01, 0.02, 0.03, 0.04, 0.05, 0.06, 0.07, 0.08, 0.09, 0.1, 0.15, 0.2, 0.25, 0.3, 0.35, 0.4, 0.45 or 0.5 W/cm K. The thermal insulator may comprise fused alumina or oriented graphite or both, or some other insulator or mixture of insulators. As noted above, the area of contact of the thermal insulator with the heat storage block should be minimised.

The heat storage block and the region of low pressure may be housed within a chamber. The chamber may be made of any suitable material that is strong enough to withstand the low pressure. The suitable material should be non-porous so as to enable it to hold a vacuum (or partial vacuum). The chamber may be made of a ceramic, or of steel or of some other suitable material. The minimum distance from the heat storage block to an inner wall of the chamber should be sufficiently great to achieve acceptably low radiative heat loss in operation. The distance may be between about 1 and about 50 cm, or between about 2 and 5, 5 and 50, 10 and 50, 20 and 50, 1 and 20, 1 and 10, 1 and 5, 5 and 10, 5 and 30, 10 and 30 or 10 and 20 cm, e.g. about 1, 2, 3, 4, 5, 10, 15, 20, 25, 30, 35, 40, 45 or 50 cm, or may be more than 50 cm. The distance may depend on the size of the block. The chamber may be connected, or connectable to, a source of vacuum, e.g. a vacuum pump. The vacuum pump may comprise an electrical pump, a diffusion pump, a piston pump or some other form of vacuum pump, and may comprise more than one of these.

The chamber may comprise a thermal insulator in order to reduce thermal losses therefrom. The thermal insulator may be on the outside of the chamber. It may be any of the well-known thermal insulators, provided that it is stable and does not melt up to the use temperature of the temperatures encountered in use. The insulator may be stable and not melt up to the melting point of the thermally conductive material of the heat storage composite.

The heater may comprise an electrical heater, a heat exchange fluid based heater, an inductive heater, an eddy current heater or some other heater. The heater may comprise a heater element located within the heat storage block, or outside but in contact with the heat storage block, or it may not be in contact with the heat storage block. Thus in some embodiments, the heater does not require a heater component within or in contact with the heat storage block. For example, induction of a current within the heat storage block by means of a heater located in or on the wall of the chamber in which the block is housed may cause the block to heat.

The heat storage composite of the present invention may be made by combining a plurality of carbon particles and a thermally conductive material and then heating the resulting mixture in a partial vacuum to a temperature above the melting point of the thermally conductive material. In doing so, it is preferable that the mixture of thermally conductive material and carbon particles is relatively homogeneous prior to the heating. This may be achieved by shaking or stirring or otherwise agitating the mixture. Alternatively or additionally, once the thermally conductive material has melted, the resulting molten mixture may be agitated in order to increase its homogeneity.

Prior to formation of the mixture, the thermally conductive material may be in particulate form. The particles of the thermally conductive material may be spherical or substantially spherical or some other shape. They may be regular shaped or they may be irregular shaped. They may have a narrow particle size. The weight average particle size of the carbon particles divided by their number average particle size may be less than about 2, or less than about 1.8, 1.6, 1.4, 1.2 or 1.1, e.g. about 1, 1.1, 1.2, 1.3, 1.4, 1.5, 1.6, 1.7, 1.8, 1.9 or 2, although in some cases it may be greater than 2 (e.g. 2 to 3). The mean particle diameter (number average or weight average) of the particles of thermally conductive material may be less than about 20 microns, or less than about 10, 5 or 2 microns, or may be between about 0.5 and about 20 microns, or about 0.5 to 10, 0.5 to 5, 0.5 to 2, 0.5 to 1, 1 to 20, 5 to 20, 10 to 20, 1 to 10, 5 to 10 or 1 to 5 microns, e.g. about 0.5, 1, 1.5, 2, 2.5, 3, 3.5, 4, 4.5, 5, 6, 7, 8, 9, 10, 11, 12, 13, 14, 15, 16, 17, 18, 19 or 20 microns. The particles of thermally conductive material may be between about 1 and about 20 microns, or may be about 1 to 10, 1 to 5, 2 to 20, 5 to 20, 10 to 20, 2 to 10, 2 to 5 or 5 to 10 microns, e.g. about 1, 2, 3, 4, 5, 6, 7, 8, 9, 10, 11, 12, 13, 14, 15, 16, 17, 18, 19 or 20 microns. The particles of thermally conductive material may be smaller than the mean particle size of the carbon particles. In the event that the thermally conductive material is an alloy of two or more metals, these metals may be mixed as individual materials or as an alloy. In the event that the metals are mixed individually, each of the metals may be as described above. On heating the mixture of metals and carbon particles, the metals melt and combine so as to form the alloy thereof between the carbon particles. Thus for example if the thermally conductive material of the heat storage composite is a copper-silver alloy, the heat storage composite may be made by combining carbon particles, copper particles and silver particles and heating the resulting mixture under a partial vacuum to a temperature above that required to form a molten alloy of copper and silver. Alternatively it may be made by combining carbon particles with particles of a copper-silver alloy and heating the resulting mixture under a partial vacuum to a temperature above the melting point of the alloy. In this context it should be noted that if an alloy is used, the ratio of metals in the alloy may be any desired ratio such that an alloy can form. Such ratios are well known to metallurgists. It should be noted that for the example of copper-silver alloys (or mixtures), a practical operating temperature is no greater than 780° C., since above this temperature at least a portion of such alloys is liquid. However when making the composite, it is preferable to heat the mixture of carbon particles and alloy (or separate metal particles) to a temperature at or above the liquidus temperature of the alloy, i.e. that temperature at which the alloy is completely melted. The liquidus temperature will vary with the ratio of copper and silver in the alloy, and is a minimum of 780° C. for about 72% silver and about 28% copper. Similar considerations may pertain for other alloys which may be used as thermally conductive materials in the present invention.

The partial vacuum may be applied to the mixture before the thermally conductive material is raised above its melting point. It will be understood that a partial vacuum may have very low absolute pressure, however a complete vacuum (i.e. absence of any gaseous material) is in practice unachievable. The absolute pressure of the partial vacuum may be less than about 0.01 atmospheres, or less than about 0.005, 0.001, 0.0005 or 0.0001 atmospheres, or about 0.01 to 0.0001 atmospheres, or about 0.01 to 0.001, 0.01 to 0.005, 0.001 to 0.0001 or 0.01 to 0.0005 atmospheres, e.g. about 0.01, 0.005, 0.001, 0.0005 or 0.0001 atmospheres. The provision of a low pressure ensures that the molten thermally conductive material is able to substantially fill the spaces between the carbon particles. The low pressure should be applied to the mixture before the thermally conductive material melts, although in some instances it may be sufficient to do so after the thermally conductive material has melted. However it is necessary that at some stage in the process, the molten thermally conductive material coexists with the carbon particles under the low pressure described above. This state should be maintained for sufficient time for the molten material to penetrate and substantially fill the spaces between the carbon particles. This time may depend on the viscosity of the molten material, which may in turn depend on the temperature. As noted, the temperature should be sufficient to melt the thermally conductive material. Melting points of suitable thermally conductive materials are for example 1084° C. (copper) and 962° C. (silver). Thus the heating may be for example to a temperature of between about 1000 and about 1500° C., or about 1000 to 1400, 1000 to 1300, 1000 to 1200, 1100 to 1500, 1200 to 1200 to 1500, 1300 to 1500, 1200 to 1400 or 1200 to 1300° C., e.g. about 10000, 1050, 1100, 1150, 1200, 1250, 1300, 1350, 1400, 1450 or 1500° C.

The process may also comprise cooling the heat storage composite to allow it to solidify. The cooling may be to a sufficiently low temperature that the composite solidifies. This temperature may be the melting point, or the solidus temperature, of the thermally conductive material.

The heat storage block of the invention may be made by making a heat storage composite as described above and forming the heat storage composite into a desired shape. The forming is preferably conducted prior to allowing the thermally conductive material to solidify. Thus the process involves combining a plurality of carbon particles and a thermally conductive material, heating the resulting mixture in a partial vacuum to a temperature above the melting point of the thermally conductive material and forming the resultant heat storage composite into the desired shape, preferably prior to allowing the thermally conductive material to solidify. The forming may comprise conducting the process in a mould in the desired shape so that when the heat storage composite cools it adopts the shape of the mould. The mould may therefore be of a suitable shape to form a block of the desired shape, as described earlier.

The process may additionally comprise the step of applying a substance of low thermal emissivity to an outer surface of said shape. This step may comprise spraying a film of said substance on said outer surface. The process may additionally comprise the step of polishing said substance of low thermal emissivity on said outer surface. The process may additionally comprise the step of applying the substance of low thermal emissivity to a surface of the heating chamber. This step may comprise spraying a film of said substance on said surface. The process may additionally comprise the step of polishing said substance of low thermal emissivity on said surface

As noted earlier, the heat storage block may comprise a heating chamber for accepting a substance to be heated by said heat storage block. This may be formed in the heat storage block when forming the block, by use of a mould having the appropriate shape. Alternatively the heating chamber may be formed after formation of the block. This may be achieved by drilling or carving or otherwise forming a heater chamber of the desired shape and size in the heater block. Thus for example a cylindrical heater chamber through the centre of the block may be formed by drilling a cylindrical cavity through the block.

The process may comprise incorporating a heater component into the heat storage block. In this event the heater component may be inserted into the mixture of carbon particles and thermally conductive material, either before the thermally conductive material has melted or after the thermally conductive material has melted. It should be inserted therein before the thermally conductive material has been allowed to cool to form the heat storage composite.

The heat storage device may be made by mounting a heat storage block (as described above) inside a chamber, providing a heater for heating said heat storage block, and removing at least part of the gas inside said chamber so as to create a region of low pressure surrounding said heat storage block. The heater may be disposed so as to be capable of heating the heat storage block. Thus if the heat storage block comprises a heater element, the heater should comprise a connector to connect to the heater element. The heater itself may then be located in, on or outside of the chamber. The nature of the connector and of the heater will depend on the nature of the heater element. For example if the heater element is an electrical element, the connector may comprise an electrical cable and the heater may comprise a source of electricity, e.g. a transformer, a generator etc. If the heater element is a conduit for accepting a heated fluid, the connector may comprise a tube or conduit that may be coupled to the heater element to form a continuous heater conduit, and the heater may comprise a fluid heater for heating the fluid so as to heat the heater block.

The mounting may comprise providing mountings which are made from a thermal insulator. These mountings have been described earlier. The process may comprise locating the heat storage block on the mountings. The mounting may be such that the contact area between the mountings and the heat storage block is minimised so as to minimise heat losses through the mountings.

The process of making the heat storage device may comprise applying a vacuum, or partial vacuum, to the space within the chamber between the inner walls of the chamber and the heat storage block. The desired vacuum has been described earlier, as have suitable pumps for applying the vacuum.

The heat storage device may be used for heating a substance. In order to achieve this, the temperature of the heat storage block of the device should be at a temperature above that of the substance prior to said heating. The substance is then exposed to the heat storage block (e.g. contacted with or passed close to the heat storage block), whereby heat energy is transferred to the block to the substance. The substance may be passed along a groove or conduit or indentation in the heat storage block. It may be passed through a heating chamber in the heat storage block.

The difference in temperature between the heat storage block and the substance prior to the heating may be between about 10 and about 1000K or more, or about 10 to 500, 10 to 200, 10 to 100, 10 to 50, 10 to 20, 20 to 1000, 50 to 1000, 100 to 1000, 200 to 1000, 500 to 1000, 50 to 500, 50 to 200, 50 to 100, 100 to 500 or 100 to 300K, e.g. about 10, 20, 30, 40, 05, 60, 70, 80, 90, 100, 150, 200, 250, 300, 350, 400, 450, 500, 550, 600, 650, 700, 750, 800, 850, 900, 950 or 1000K. The substance may be heated to a temperature of between about 100 and about 1000° C., or about 100 to 500, 100 to 200, 200 to 1000, 500 to 1000, 200 to 500 or 300 to 700° C., e.g. about 100, 150, 200, 250, 300, 350, 400, 450, 500, 550, 600, 650, 700, 750, 800, 850, 900, 950 or 1000° C. The rate of passage of the substance past or through the heat storage block and the temperature difference between the heat storage block and the substance before the heating may be sufficient to heat the substance to the desired temperature, as described above.

The method for heating the substance may comprise heating the heat storage block to a suitable operating temperature using the heater prior to exposing the substance to the heat storage block. The heating may use the heater and/or the heating element. The heater block may be heated to a suitable temperature, which is above the temperature of the substance before heating. It may be heated to a temperature above the desired temperature of the substance after heating. It may for example be to a temperature of between about 100 and about 1000° C., or about 100 to 500, 100 to 200, 200 to 1000, 500 to 1000, 200 to 500 or 300 to 700° C., e.g. about 100, 150, 200, 250, 300, 350, 400, 450, 500, 550, 600, 650, 700, 750, 800, 850, 900, 950 or 1000° C. It may be to a temperature greater than 1000° C., depending on the melting temperature of the thermally conductive material.

The increase in temperature of the substance may depend on a variety of factors:

1) the surface area of the heating chamber—a higher surface area may provide a larger temperature increase;

2) the length of the heating chamber—a longer heating chamber may provide a larger temperature increase;

3) the rate of passage of the substance through the heating chamber—a slower passage may provide a larger temperature increase;

4) the heat capacity of the substance—a higher heat capacity substance may experience a smaller temperature increase

5) the temperature of the heat storage block—a hotter heat storage block may provide a larger temperature increase

6) the initial temperature of the substance—a hotter substance may experience a smaller temperature increase.

It will be recognised that factors 2 and 3 combine to determine the residence time of the substance in the heating chamber. A longer residence time will in general provide a greater temperature increase. Also factors 5 and 6 combine to determine the temperature differential between the substance before heating and the heat storage block. A larger temperature differential will in general provide a greater temperature increase, although if this temperature differential is achieved by lowering the initial temperature of the substance rather than raising the temperature of the heat storage block, the final temperature of the substance as it leaves the device may be lower even though the temperature increase is greater.

In an alternative mode of use for the heat storage device of the present invention, the heat storage block may be heated by passing a heated heating substance (commonly a heated gas or a heated liquid, although a heated powder, heated foam, heated emulsion, heated aerosol etc. may be used) through the heating chamber of the heat storage block so as to raise the temperature of the block to a desired temperature. Once the desired temperature is achieved, the heat energy of the block may be imparted to a substance to be heated (as described earlier) by passing said substance past or into, optionally through, the heating chamber as described earlier.

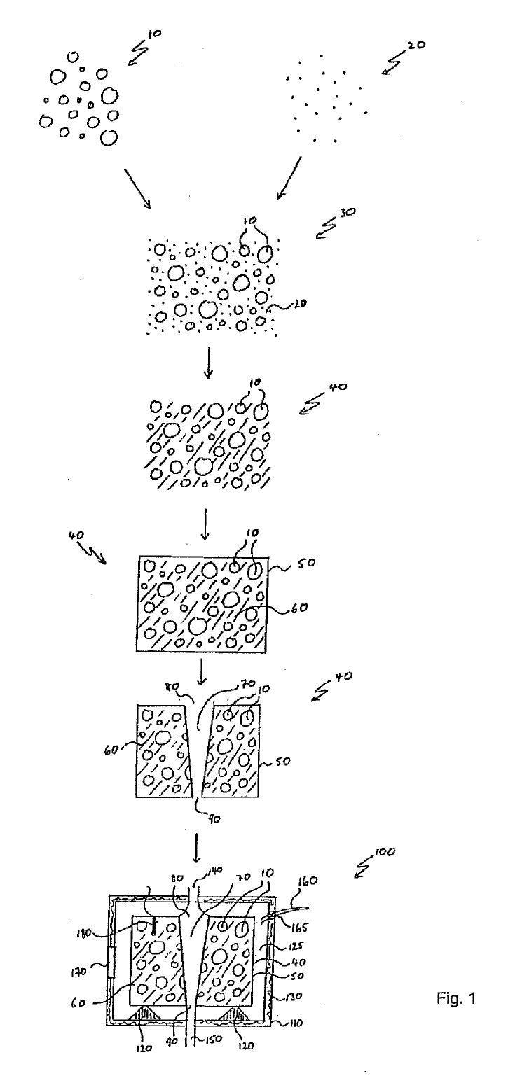

FIG. 1 is a diagram illustrating the manufacture of a heat storage device according to the present invention. Thus carbon particles 10 and copper particles 20 are combined to form mixture 30. The mixture may be agitated in order to achieve a suitable distribution of particles. Commonly carbon particles 10 are spherical graphite particles of particle diameter about 100 to 500 microns, and have a broad particle size distribution. This enables smaller particles to fit in the spaces between larger particles. Copper particles 20 are commonly smaller, for example about 1 to 5 microns, enabling them to fit in the spaces between carbon particles 10. Mixture 30 is then heated to above the melting point of copper (1084° C.), for example to about 1200° C. under a vacuum of about 0.01 atmospheres in a mould (not shown in FIG. 1). Copper particles 20 then melt and fill the spaces between carbon particles 10. At this stage the mixture may be agitated, e.g. stirred, in order to increase or maintain homogeneity. Prior to allowing the copper in the mixture to solidify, it may be desirable to raise the pressure to near atmospheric pressure in order to reduce or minimise voids in the mixture. On cooling, a solid block 40 of heat storage composite is formed. It may then be removed from the mould. A thin layer 50 of copper is then formed on the outside surface of the block by spraying the block with molten copper, so that block 40 comprises heat storage composite 60 (comprising a conglomerate of carbon particles 10 with copper in the spaces between them) with copper layer 50. After layer 50 has cooled and solidified, it is then polished to form a low emissivity layer on the surface of block 40. A heating chamber 70 is then formed in block 40. This may be achieved by drilling chamber 70 in the form of a conical cavity through block 40. At this stage, then, block 40 comprises block 40 having layer 50 as its outer surface, and conical heating chamber 70 passing vertically therethrough. Chamber 70 has chamber inlet 80 at its upper end and chamber outlet 90 at its lower end.

Heating block 40 may then be incorporated into heat storage device 100. Thus heat storage block 40 may be mounted inside chamber 110 such that chamber inlet 80 is at the top of block 40 and chamber outlet 90 is at the bottom of block 40. Block 40 is mounted on mounting blocks 120 made of an insulator such as fused alumina. Commonly there will be 3 mounting blocks 120, so as to minimise the contact area between block 40 and mounting blocks 120. The distance between block 40 and chamber 110 is preferably between about 5 and 10 cm, and so mounting blocks 120 will commonly be about 5 to 10 cm high. Thus block 40 and chamber 110 define space 125 therebetween. Mounting chamber 110 commonly comprises insulation 130 around the outside to further minimise heat loss from device 100. Inlet tube 140 is coupled to chamber inlet 80 so as to admit a substance to be heated into heating chamber 70, and outlet tube 150 is coupled to chamber outlet 90 so as to allow the heated substance to exit device 100. Preferably inlet tube 140 and outlet tube 150 are made from materials that have low thermal conductivity, so as to reduce heat losses from device 100, since both tubes penetrate chamber 110. Chamber 110 is also fitted with a vacuum connection 160, to enable space 125 between block 40 and chamber 110 to be at least partially evacuated. Vacuum connection 160 may also comprise valve 165, which when open allows space 125 to be evacuated, and when closed enables space 125 to be sealed thereby maintaining a vacuum in space 125. It is clearly desirable that the connections between chamber inlet 80 and inlet tube 140, and between chamber outlet 90 and outlet tube 150 are as gas tight as possible, so as to allow a vacuum to be maintained in space 125. Similarly the penetrations in chamber 110 through which tubes 140 and 150 pass should also be as gas tight as possible. Chamber 110 is also provided with eddy current heater 170. As shown in FIG. 1, heater 170 is only on one side of chamber 110, however there may be separate heaters 170 on each side of chamber 110, or a single heater 170 may be located completely around chamber 110. Eddy current heater 170 is capable of inducing eddy currents within block 40 so as to heat block 40 to a desired temperature. As noted earlier, alternative heating methods may be used. For example a heater element may be located in block 40 and connected to a source of electrical power in or outside chamber 110, or a heater fluid conduit may be embedded in block 40 and connected to a source of heated fluid in or outside chamber 110. Block 40 may also be fitted with a temperature sensor 180 (either embedded therein, as shown, or on the surface thereof) for determining the temperature of block 40. A suitable temperature sensor may for example be a thermocouple.

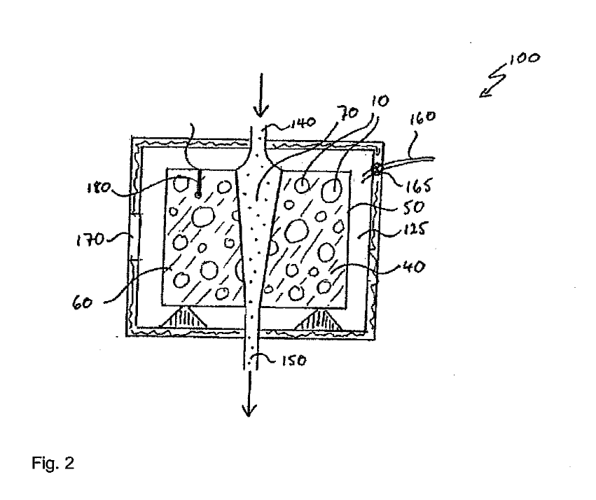

FIG. 2 illustrates the use of heat storage device 100 of FIG. 1. Thus in operation of device 100, a vacuum is applied to vacuum connection 160 with valve 165 open, for example by means of a suitable vacuum pump, until the pressure in space 125 is below about 0.01 atmospheres. This may be measured for example by means of a pressure sensor (not shown) located in space 125. Vacuum may continue to be applied to space 125 throughout operation of device 100, or valve 165 may be closed so as to maintain the vacuum in space 125. An electric current is then passed through eddy current heater 170, so as to induce an electric current within block 40 and thereby cause block 40 to increase in temperature. Thermocouple 180 is used to monitor the temperature of block 40, and heating is continued until the temperature of block 40 reaches a desired temperature (which should be below the melting point of copper), for example 950° C. The substance to be heated by system 100 is passed into heating chamber 70 by way of inlet tube 140, as shown by the upper arrow of FIG. 2. As the substance passes through chamber 70, heat is transferred from the walls of the chamber to the substance by conduction when the substance contacts the walls, and possibly also by convection through a fluid (gas or liquid) in the chamber. In some cases the substance may be, or may comprise, the fluid (either gas or liquid). After passing through chamber 70, the substance passes out of device 100 by way of outlet tube 150, as shown by the lower arrow in FIG. 2. As heat energy is transferred to the substance, the temperature of block 40 may drop. This may be detected by thermocouple 180, which may then signal heater 170 to heat the block until the desired temperature of block 40 is restored. Thus system 100 may have a feedback loop or thermostat in order to maintain block 40 at the desired operating temperature, or within a desired range of operating temperatures.

1. A heat storage composite comprising:
a plurality of carbon particles; and
a thermally conductive material, said material being different to the carbon particles.

2. The heat storage composite of claim 1 wherein the carbon particles are substantially homogeneously distributed in the thermally conductive material.

3. The heat storage composite of claim 1 wherein the carbon has a purity of at least about 99% by weight.

4. The heat storage composite of claim 1 wherein the carbon is in the form of graphite.

5. The heat storage composite of claim 1 wherein the mean particle diameter of the carbon particles is less than about 2 mm.

6. The heat storage composite of claim 1 wherein the carbon particles have a broad particle size distribution.

7. The heat storage of claim 1 wherein the carbon particles are substantially spherical.

8. The heat storage composite of claim 1 wherein the composite comprises at least about 50% by volume of carbon particles.

9. The heat storage composite of claim 1 wherein the thermally conductive material is a metal or a metal alloy.

10. The heat storage composite of claim 9 wherein the thermally conductive material is copper, silver or a copper-silver alloy.

11. The heat storage composite of claim 1 wherein the plurality of carbon particles define spaces between said particles, and substantially all of the spaces are occupied by the thermally conductive material.

12. A heat storage block comprising the heat storage composite of claim 1.

13. The heat storage block of claim 12 comprising an outer layer, said outer layer consisting of a substance of low thermal emissivity.

14. The heat storage block of claim 13 wherein the substance of low thermal emissivity is highly polished.

15. The heat storage block of claim 12 wherein the substance of low thermal emissivity is the same as the thermally conductive material.

16. The heat storage block of claim 12 in the form of a rectangular parallelepiped.

17. The heat storage block of claim 12 comprising a heating chamber for accepting a substance to be heated by said heat storage block.

18. The heat storage block of claim 17 wherein said heating chamber is designed so as to allow the substance to pass through said heating block.

19. The heat storage block of claim 12 additionally comprising a heater component for heating said heat storage composite.

20. A heat storage device comprising:
a heat storage block according to claim 12 mounted in a region of low pressure; and
a heater for heating said heat storage block.

21. The heat storage device of claim 20 wherein the heat storage block is mounted in said region of low pressure by means of a thermal insulator.

22. The heat storage device of claim 21 wherein said thermal insulator comprises fused alumina or oriented graphite or both.

23. A process for making a heat storage composite comprising:
combining a plurality of carbon particles and a thermally conductive material to form a mixture; and
heating said mixture in a partial vacuum to a temperature above the melting point of the thermally conductive material.

24. The process of claim 23 wherein the partial vacuum is applied to the mixture before the thermally conductive material is raised above its melting point.

25. A heat storage composite made by the process of claim 23.

26. A process for making a heat storage block comprising:
making a heat storage composite according to the process of claim 23; and
forming the heat storage composite into a desired shape.

27. The process of claim 26 additionally comprising the step of applying a substance of low thermal emissivity to an outer surface of said shape.

28. The process of claim 16 additionally comprising the step of polishing said substance of low thermal emissivity on said outer surface.

29. The process of claim 26 wherein the desired shape is a rectangular parallelepiped.

30. The process of claim 26 wherein said desired shape comprises a heating chamber for accepting a substance to be heated by said heat storage block.

31. The process of claim 30 wherein said heating chamber comprises a cone or a cylinder passing substantially vertically through said block.

32. The process of claim 26 comprising incorporating a heater component into the heat storage block.

33. A heat storage block made by the process of claim 26.

34. A process for making a heat storage device comprising:
providing a heat storage block according to claim 12;
providing a heater for heating said heat storage block;
mounting said heat storage block inside a chamber; and
removing at least part of the gas inside said chamber so as to create a region of low pressure surrounding said heat storage block.

35. The process of claim 34 wherein the step of providing the heat storage block comprises making said heat storage block using the process of claim 26.

36. A heat storage device made by the process of claim 34.

37. A method for heating a substance comprising:
a) providing a heat storage device according to claim 20 wherein the heat storage block of said device is at a temperature above that of the substance; and
b) exposing the substance to the heat storage block so as to heat the substance.

38. The method of claim 37 wherein step a) comprises heating the heat storage block to said temperature using the heater.

39. The method of claim 37 wherein step b) comprises passing the substance through a heating chamber in said block, said chamber being designed so as to allow the substance to pass through said heating block.

40. A heated substance when heated by the method of claim 37.
